(19) United States
(12) Patent Application Publication
(10) Pub. No.: US 2012/0274288 A1
(43) Pub. Date: Nov. 1, 2012

(54) PROVIDING IN RUSH CURRENT TOLERANCE TO AN ELECTRONIC DEVICE

(76) Inventor: Rudolf Wegener, Le Versoud (FR)

(21) Appl. No.: 13/386,053

(22) PCT Filed: Sep. 23, 2009
(86) PCT No.: PCT/US09/58090

§ 371 Date: Jan. 20, 2012

(51) Int. Cl. H02J 7/00; H01R 43/00

(52) U.S. Cl. 320/166; 29/825

(57) ABSTRACT

According to one embodiment, an apparatus (100) for providing in rush current tolerance to an electronic device comprises a bulk capacitor (140), a resistor network (150), and a power switch (160). The resistor network (150) is configured for charging the bulk capacitor (140) slowly by impeding current from the power grid to the bulk capacitor (140). The power switch (160) is configured for causing the bulk capacitor (140) to be charged slowly using the resistor network (150) when the power switch (160) is off and for causing the bulk capacitor (140) to be charged more quickly without impeding current through the resistor network (150) when the power switch (160) is on.

### RELATED APPLICATION

This application is related to EPO patent application, Serial Number 07291045.8 by Wegener, et al., filed on Aug. 28, 2007 and entitled “METHOD AND APPARATUS FOR A POWER CONVERSION DEVICE” with attorney docket no. HP 200700363-1, assigned to the assignee of the present invention.

### BACKGROUND

When an electronic device is connected to the alternating current (AC) power grid, for example, by plugging the electronic device into a wall socket, a significant inrush of current, also known as “inrush current,” flows as the bulk capacitor associated with the electronic device is charged for the first time The peak value of the inrush current can be several hundred times higher than the normal operating current providing a short but very high energy stress on the electronic device's components that reside along the inrush current path. The high inrush current can contribute to any one or more of degraded operation, reliability issues, and failure of the components along the inrush current path.

In countries that have reliable AC power networks the inrush current, experienced by an electronic device will have little variance and will reliably be at a level that the electronic device is designed to withstand. However, in emerging countries, such as China and India, for example, there are known power grid problems. In particular, line voltage variance in the form of high line voltages that are as much as two times the nominal line voltage may commonly occur. These high line voltage events may last from a few milliseconds to several hours. Specifically, the high line voltage events, even those lasting for only milliseconds have been proven to pose reliability issues. As electronic devices are increasingly being shipped to the emerging markets, manufacturers are encountering increased warranty repair costs due to components failing from high inrush current.

Conventionally, techniques to improve tolerance to high line voltage events include using Negative Temperature Coefficient (NTC) inrush current resistors or a combination of a standard resistor and a by pass switch. These conventional techniques are costly, complex, and inadequate to deal with the problems associated with emerging market power networks, or result in additional power loss, or a combination thereof. The background section is not an admission of prior art.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 is a block diagram of an apparatus for providing in rush current tolerance to an electronic device, according to one embodiment.

FIG. 2 depicts a block diagram of another apparatus for providing in rush current tolerance to an electronic device, according to one embodiment.

FIG. 3 depicts an illustrative graph of the power switch's gate voltage, the bulk capacitor's voltage, and the power switch's current, according to one embodiment.

FIG. 4 depicts a block diagram of yet another apparatus for providing in rush current tolerance to an electronic device, according to one embodiment.

FIG. 5 depicts a flowchart of a method for manufacturing an apparatus that provides in rush current tolerance for an electronic device, according to one embodiment.

The drawings referred to in this Brief Description should not be understood as being drawn to scale unless specifically noted.

### DESCRIPTION OF EMBODIMENTS

According to one embodiment, an in rush current tolerant apparatus is provided. Conventional bulk capacitors are typically charged in half of a line cycle or in one line cycle, which takes, for example, approximately 10 to 20 milliseconds. According to one embodiment, an in rush current tolerant apparatus is provided by charging the bulk capacitor more slowly than conventional bulk capacitors thus, reducing the probability of damaging components along the inrush current path and reducing additional power loss, among other things. For example, according to one embodiment, a bulk capacitor is charged over a period of time that may last approximately 1.5 seconds. Typically, the product specification for, most electronic devices specifies that the electronic device can be started in 1 to 2 seconds. Thus, taking approximately 1.5 seconds to charge the bulk capacitor still enables the electronic device to be started within the time frame specified by product specifications while at the same time reducing the probability of damaging components along, the inrush current path and reducing additional power loss, among other things.

According to one embodiment, a bulk capacitor is charged in three phases. In the first phase, the bulk capacitor is charged slowly using a resistor network. For example, in the first phase, current from the power grid goes through a resistor network which impedes the current flow to the bulk capacitor. In the second phase, the bulk capacitor is charged more quickly than in the second phase. For example, in the second phase, the rate that the bulk capacitor is charged is alternated between slow and quick by alternating between charging the bulk capacitor using current impeded by the resistor network and using line current without impeding current through the resistor network. In the third phase, the bulk capacitor is charged quickly without impeding current through the resistor network. The length of time that each stage takes can be programmed. For example, the length of time of the phases can be programmed based on the total resistance value of resistors associated with the resistor network.

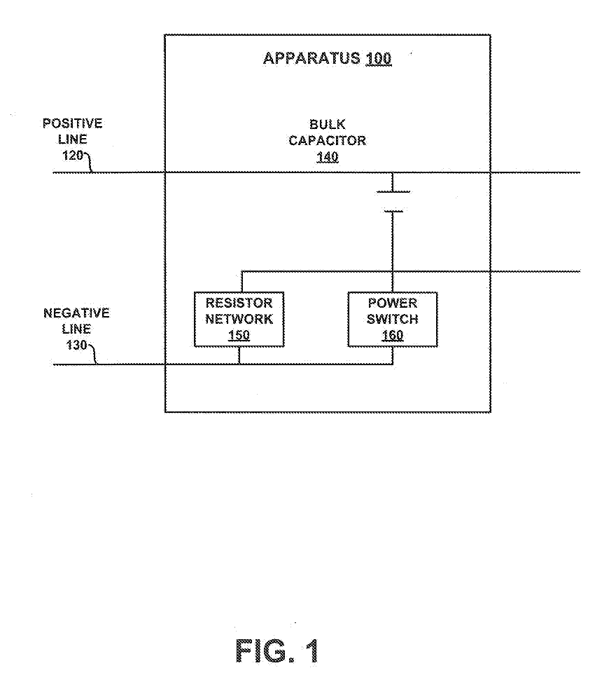

FIG. 1 is a block diagram of an apparatus 100 for providing in rush current tolerance to an electronic device, according to one embodiment. The blocks that represent features in FIG. 1 can be arranged differently than as illustrated, and can implement additional or fewer features than what are described herein. Further, the features represented by the blocks in FIG. 1 can be combined in various ways. The apparatus 100 can be implemented using hardware, hardware and software, hardware and firmware, or a combination thereof.

The apparatus 100 includes a bulk capacitor 140, a resistor network 150, and a power switch 160. The bulk capacitor 140 is connected to a positive line 120 and the resistor network 150 is connected to a negative line 130. The positive line 120 and the negative line 130 may be associated with a bus from a line voltage rectifier, according to one embodiment, as will become more evident. Although line 130 is depicted as a negative line, line 130, according to one embodiment, is, a stable reference line that can be positive, negative or neutral. The apparatus 100 can provide in rush current tolerance to an electronic device, for example, by residing in the electronic device or by being plugged into the electronic device.

The resistor network 150 is configured for charging the bulk capacitor 140 slowly. The resistor network 150, according to one embodiment, is a resistor divider network (also known as a “voltage divider”). According to one embodiment, the resistor network 150 is a high impedance resistor network 150. As will become more evident, the power switch 160 is configured for causing the bulk capacitor 140 to be charged slowly by impeding current through the resistor network 150 when the power switch 160 is off and for causing the bulk capacitor 140 to be charged more quickly without impeding current through the resistor network 150 when the power switch 160 is on. The resistor network 150 limits the current flowing into the bulk capacitor 140 and provides a voltage for turning the power switch 160 off, as will become more evident according to various embodiments. As will become more evident, the bulk capacitor 140, the power switch 160, and the resistor network 150 provide an in rush current tolerant topology, according to various embodiments.

According to one embodiment, the total resistance value of the resistors associated with the resistor network 150 is significantly higher resistance than conventional inrush limiting resistors. According to one embodiment, the total resistance value of the resistors associated with the resistor network 150 is approximately 1000 times higher than the resistance of conventional inrush limiting resistors. According to one embodiment, the total of the resistance values associated with resistor network 150, according to one embodiment, is approximately in the range of 2 kilo ohms to 20 kilo ohms. In one example, total resistance of the resistor network 150 is approximately 5.5 kilo ohms.

According to one embodiment, the power switch 160 is turned on and off based on a threshold. According to one embodiment, the threshold is programmable. For example, a threshold can be “programmed” based on the total value of the resistors associated with the resistor network 150. The threshold can be programmed to achieve a specified level of in rush current reduction, or even in rush current elimination. Although various embodiments are described in the context of a threshold of 150 volts, various embodiments are well suited to other thresholds.

The following describes the apparatus 100 (FIG. 1) in the context of the three phrases, according to one embodiment. During phase 1, the bulk capacitor 140 is charged slowly by impeding current through the resistor network 150. For example, the bulk capacitor 140 is charged slowly using, for example, only the resistor network 150 until a voltage across the resistor network 150 is insufficient to keep the power switch 160 off. More specifically, the voltage of the bulk capacitor 140 increases as the bulk capacitor 140's charge increases. The increase in the bulk capacitor 140's voltage causes the voltage across the resistor network 150 to decrease progressively making it progressively more difficult for the resistor network 150 to keep the power switch 160 off. Eventually, the charge associated with the bulk capacitor 140 rises causing the voltage across the resistor network 150 to decrease to a point that the power switch 160 can be turned on.

During phase 2, the bulk capacitor 140 is charged by alternating between charging the bulk capacitor 140 slowly using the resistor network 150 and charging the bulk capacitor 140 quickly without impeding current through the resistor network 150. As described in phase 1, the power switch 160 is offend the bulk capacitor 140 is being charged, for example, only through the resistor network 150. Phase 2 is entered when the charge associated with the bulk capacitor 140 rises to a point that the resistor network 150 cannot keep the power switch 160 off.

When an electronic device is connected to the power grid, the electronic device receives alternating current (AC). Typically, the wave form has periods where one half of each period is negative and, one half of each period is positive in an alternating pattern. Depending on the application, the wave form may be a sine wave, a triangular wave, or a square wave, among other things. In a specific example, in many European countries, the AC current is 50 Hertz. One line cycle lasts approximately 20 milliseconds and a half line cycle lasts approximately 10 milliseconds. At time T0, the line voltage is zero and rises peak at approximately the square root of 230 volts. Between 0 and 5 milliseconds, the line voltage is progressively rising from 0 to 310 volts. At some point in time the line voltage rises above a programmable threshold, such as 150 volts.

A line voltage rectifier 230 associated with the electronic device converts the alternating current into direct current (DC). Rectifying the alternating current into direct current involves modifying the alternating current so that the is all positive or all negative depending on the desired application. For example, in the case of a positive direct current, the negative half waves of the AC are modified to, be positive. Various embodiments described herein shall be described in the context of a positive direct current. However, various embodiments are well suited for a negative direct current.

According to one embodiment, the power switch 160 will be turned on and off as the instantaneous sinusoidal line voltage associated with the DC current rises above and falls below a programmable threshold, such as 150 volts the threshold can be programmed based on the total resistance value of the resistors associated with the resistor network 150, according to one embodiment. For example, at some point in time after the instantaneous sinusoidal line voltage rises above the threshold, the power switch 160 will be turned on. When the power switch 160 is on, the bulk capacitor 140 is charged more quickly because the current is not impeded by the resistor network 150. At some point in time after an instantaneous sinusoidal line voltage falls below the threshold, the power switch 160 turns back off. When the power switch 160 is off, the bulk capacitor 140 is charged slowly, for example, only through the resistor network 150.

According to one embodiment, there is a competition between turning the power switch 160 on and turning the switch 160 off. For example, the current drawn from the line is a function of the voltage difference between the line voltage and the voltage associated with the bulk capacitor 140. The voltage associated with the bulk capacitor 140 progressively, increases as the charge associated with the bulk capacitor 140 progressively increases. Therefore, as the bulk capacitor 140 is progressively charged, the amount of time it takes to turn the power switch 160 on will decrease and the amount of time it takes to turn the power switch 160 off will increase. Eventually, the bulk capacitor 140 is charged causing the voltage across the resistor network 150 to decrease to a point that the resistor network 150 stops influencing the power switch 150:

During phase 3, the bulk capacitor 140 is charged quickly without impeding current through the resistor network 150. Since the resistor network 150 stops influencing the power switch 160, the power switch 160 will turn on as soon as the instantaneous sinusoidal line voltage exceeds the threshold. The bulk capacitor 140 is charged more quickly when current is not impeded through the resistor network 150. The bulk capacitor 140 is charged to the peak voltage of the rectified line voltage for example, in one line shot, as will become more evident. In the case of many Europe countries, the peak voltage is approximately 230 volts.

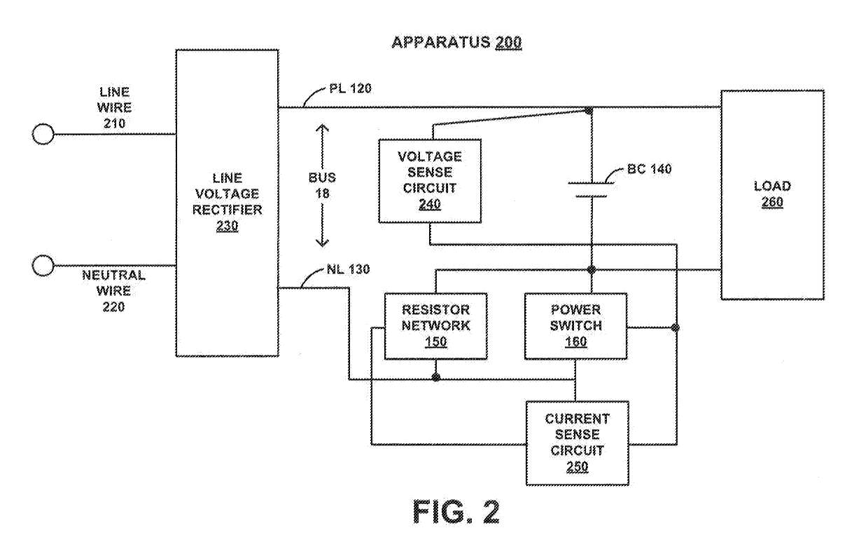

FIG. 2 depicts a block diagram of another, apparatus 200 for providing in rush current tolerance to an electronic device, according to one embodiment. The blocks that represent features in FIG. 2 can be arranged differently than as illustrated, and can implement additional or fewer features than what are described herein. Further, the features represented by the blocks in FIG. 2 can be combined in various ways. The apparatus 200 can be implemented using hardware, hardware and software, hardware and firmware, or a combination thereof.

As depicted in FIG. 2, apparatus 200 can be used as a part of a power supply or a power conversion device. The apparatus 200 depicted in FIG. 2 includes a bus 18, a voltage sense circuit 240, a bulk capacitor 140, a resistor network 150, a power switch 160, and a current sense circuit 250. The bus 18 includes a positive line (+) 120 and a negative line (−) 130. The apparatus 200 may also include any one or more of a line wire 210, a neutral wire 220, a line voltage rectifier 230, a load 260, and a control circuit.

The line voltage rectifier 230 may be a bridge rectifier circuit common in the art configured to output a rectified voltage to a bus 18. The voltage sense circuit 240 may be implemented as a resistor network. According to one embodiment, the voltage sense circuit 240 is implemented as a resistor divider network (also known as a “voltage divider”). According to one embodiment, the voltage sense circuit 240 includes three or more resistors, as will become more evident.

According to one embodiment, the resistor network 150 may be implemented using two or more resistors. In another embodiment, the resistor network 150 may be implemented using one or more resistors and an active current reading device. The resistors associated with the resistor network 150, according to one embodiment, are standard resistors that do not depend on temperature, voltage, or current.

According to one embodiment, the total resistance value of the resistors associated with the resistor network 150 is significantly higher resistance than conventional inrush limiting resistors. For example, assuming that the resistor network 150 includes two resistors, according to one embodiment, a first resistor may be a 5 Kilo ohm resistor and a second resistor may be a 460 Ohm resistor. The total of the resistance provided by the resistor network 150, according to one embodiment, is approximately 5.5 kilo ohms.

The power switch 160 may be an insulated gate bipolar transistor (IGBT), a bipolar transistor, a relay, a MOSFET, or any other suitable switch that provides a substantially instantaneous response. The particular type of power switch 160 selected may depend on system-related and business-related constraints, which may vary from one implementation to another. According to one embodiment, the current sense circuit 250 is implemented with a resistor and a bipolar transistor. However, embodiments are well suited for using any method of sensing current can be used. According to one embodiment the optional control circuit is a diode. The optional control circuit can be any circuit that is well suited for controlling the power switch 160 based on, instructions received from a voltage sense circuit 240 or a current sense circuit 250. The optional control circuit, according to one embodiment, is connected to the power switch 160, the voltage sense circuit 240, and the current sense circuit 250

The voltage sense circuit 240 turns the switch 160 on at some point in time after the instantaneous line voltage exceeds a threshold, according to one embodiment. The current sense circuit 250 turns the power switch 160 off, according to one embodiment. For example, the current sense circuit 250 can actively turn the power switch 160 off. According to one embodiment the resistor network 150 limits the current flowing into the bulk capacitor 140. The resistor network 150 may also provide a voltage to the current sense circuit 250, which in turn actively turns the power switch 160 off. Either one of the resistors associated with the resistor network 150 or an active current reading device associated with the resistor network 150 can be used for actively turning the power switch 160 off. The control circuit receives instructions from either the voltage sense circuit 240 or the current sense circuit 250, and turns the power switch 160 on or off in response to received instructions, according to one embodiment.

According to one embodiment, the apparatus 200 is connected into the power grid at lines 210, 220 and is connected to a system, as represented by load 260. The apparatus 200, according to one embodiment, provides current from the bower grid to the system, as represented by load 260, while limiting in rush current to the system.

The following shall describe the apparatus 200 depicted in FIG. 2 in the context of the three phases, according to one embodiment. During phase 1, the bulk capacitor 140 is charged slowly using the resistor network 150. For example, the voltage, across the resistor network 150 is sufficiently high so that the current sense circuit 250 prevents the voltage sense circuit 240 from turning the switch 160 on. Since the switch 160 is off, the bulk capacitor 140 is charged slowing because current from the power grid is impeded by the resistor network 150 as it flows to the bulk capacitor 140. Eventually, the charge associated with the bulk capacitor 140 will rise causing the voltage across the resistor network 150 to decrease to a point that the power switch 160 can be turned on and phase 2 begins, according to one embodiment.

During phase 2, the bulk capacitor 140 is charged by alternating between charging the bulk capacitor 140 slowly through the resistor network 150 and charging the bulk capacitor 140 quickly based on line voltage without impeding current through the resistor network 150. During phase 2, the bulk capacitor 140 is charged slowly and quickly in an alternating manner. For example, the switch 160 is turned on once per half line cycle at some point in time after the instantaneous sinusoidal line voltage exceeds the threshold and is turned off once per half line cycle at some point in time after the instantaneous sinusoidal line voltage falls below the threshold.

The bulk capacitor 140 is charged slowly using the resistor network 150 when the power switch 160 is off and is charged more quickly without using the resistor network 150 to impede current when the switch 160 is on. There is a competition between the voltage sense circuit 240 turning the switch 160 on and the current sense switch actively turning the switch 160 off, according to one embodiment. For example, the current drawn from the line is a function of the voltage difference between the line voltage and the voltage associated with the bulk capacitor 140. The voltage associated with the bulk capacitor 140 progressively increases as the charge associated with the bulk capacitor 140 progressively increases.

The level of the voltage across the resistor network 150 is based upon the difference of the rectified line voltage and the bulk capacitor 140's voltage. As the voltage across the bulk capacitor 140 progressively increases, the voltage across the resistor network 150 progressively weakens. Since the voltage across the resistor network 150 drives the current sense circuit 250, according to one embodiment, the current sense circuit 250 progressively losses its ability to keep the switch 160 off and the voltage sense circuit 240 progressively becomes more capable of keeping the switch 160 on. The amount of time it takes for the voltage sense circuit 240 to turn the power switch 160 on and the amount of time it takes for the current sense circuit 250 to cause the power switch 160 to be turned off is a function of the voltage associated with the bulk capacitor 140 and the resistor network 150, according to one embodiment. Therefore, as the bulk capacitor 140 is progressively charged, the amount of time it takes for the voltage sense circuit 240 to turn the power switch 160 on will decrease and the amount of time it takes for the current sense circuit 250 to cause the power switch 160 to be turned off will increase.

During phase 3, the bulk capacitor 140 is charged quickly using the line voltage without impeding current through the resistor network 150. For example, the bulk capacitor 140 is charged to the point that the voltage associated with the bulk capacitor 140 enables the voltage sense circuit 240 to turn the switch 160 on as soon as the instantaneous sinusoidal line voltage exceeds the threshold. The bulk capacitor 140 is charged to the peak voltage of the rectified line voltage. According to one embodiment, the bulk capacitor 140 is charged in phase 3 in one line shot, as will become more evident.

According to one embodiment, an apparatus 100, 200 (FIG. 1 or 2), includes means for charging a bulk capacitor 140 slowly, means for charging a bulk capacitor 140 more quickly, and means for alternating between the means for charging the bulk capacitor 140 slowly and the means for charging the bulk capacitor 140 more quickly. According to one embodiment, the means for charging slowly includes a resistor network 150. According to one embodiment, the means for charging more quickly includes line voltage to charge the bulk capacitor 140 without impeding current through the resistor network 150. According to one embodiment, the means for alternating includes a power switch 160. According to one embodiment, the means for alternating may also include a voltage sense circuit 240, a current sense circuit 250, or a control circuit, or a combination thereof.

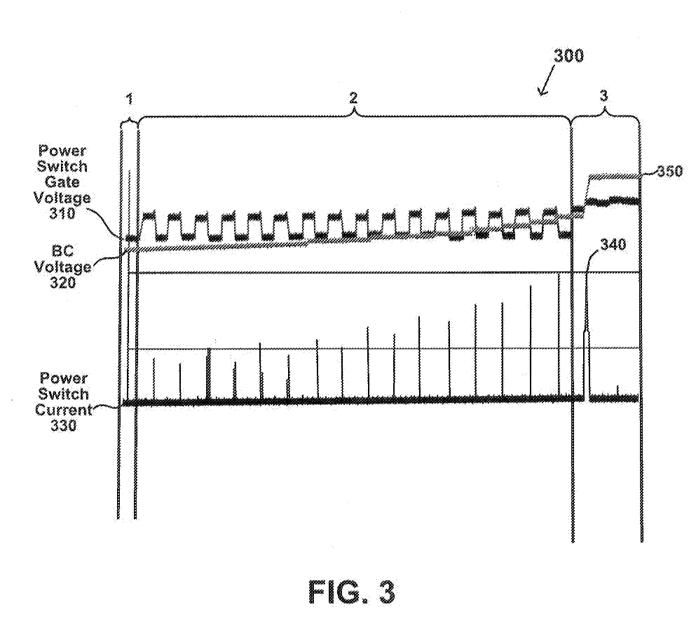

FIG. 3 depicts an illustrative graph of the power switch 160's gate voltage 310, the bulk capacitor 140's voltage 320, and the power switch 160's current 330, according to one embodiment, with respect to the three phases 1, 2, and 3. For example, as depicted in FIG. 3, the bulk capacitor 140's voltage 320 rises steadily across phase 1 and 2. Shortly after phase 3 begins, the bulk capacitor 140's voltage 320 rapidly increases and then plateaus.

More specifically, in phase 1, the voltage 310 at the power switch 160's gate is low and the power switch 160 is off, as depicted in FIG. 3. Therefore, the bulk capacitor 140 is being charged slowly because it is being charged only through the resistor network 150, according to one embodiment.

In phase 2, as depicted in FIG. 3, the power switch 160's current 330 spikes repeatedly in response to repeated voltage 310 increases at the power switch 160's gate. The bulk capacitor 140 is being charged more rapidly in phase 2 than in phase 1 because it is being charged slowly and rapidly in an alternating manner respectively by impeding current through the resistor network 150 and without impeding current through the resistor network 150, as described herein. As phase 2 progresses the voltage 310 at the power switch 160's gate progressively increases. The height of the spikes and the length of time associated with the spikes of the power switch current 330 increases in response to the increased voltage 310 at the power switch 160's gate. In response, the bulk capacitor 140 is progressively charged more and more rapidly as indicated by line 320.

In phase 3, the voltage 310 at the power switch 160's gate reaches a level that the power switch 160 responds rapidly to the voltage 310 rising above the programmed threshold. The power switch 160 turns on. The final spike 340 in the power switch current 330 indicates that the power switch 160 remains on for a sufficient amount of time that the bulk capacitor 140 is charged rapidly, as indicated by the quickly rising bulk capacitor voltage 320 after phase 3, to level 350, such as the peak of the line voltage.

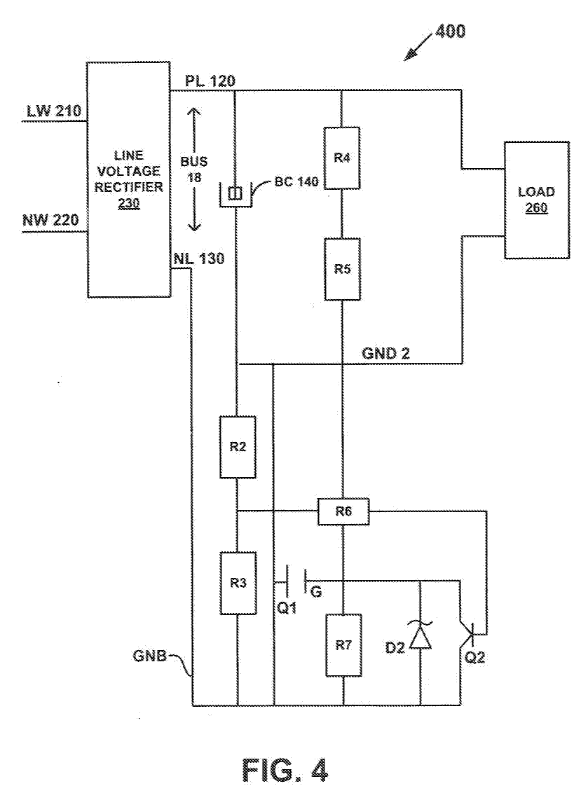

FIG. 4 depicts a block diagram of yet another apparatus 400 for providing in rush current tolerance to an electronic device, according to one embodiment. The blocks that represent features in FIG. 4 can be arranged differently than as illustrated, and can implement additional or fewer features than what are described herein. Further, the features represented by the blocks in FIG. 4 can be combined in various ways. The apparatus can be implemented using hardware, hardware and software, hardware and firmware, or a combination thereof.

The apparatus 400 includes a line wire 210, a neutral wire 220, a line voltage rectifier 230, a bulk capacitor 140, resistors R2-R7, transistors Q1, Q2, a zener diode D2, and a load 260. As depicted in FIG. 4, a resistor network 150 is implemented with resistors R2, R3, a voltage sense circuit 240 is implemented with R4, R5, R7, a current sense circuit 250 is implemented with a resistor R6 and a bipolar transistor Q2, a power switch 160 is implemented with a MOSFET Q1, and the optional circuit is implemented with a diode D2.

According to one embodiment, the resistors R2 and R3 are standard resistors that do not depend on voltage, current, or temperature to provide resistance. According to one embodiment, the resistors R2, R3 provide significantly higher resistance than conventional inrush limiting resistors. For example, according to one embodiment, the total resistance value of the resistors associated with the resistor network R2, R3 is approximately 1000 times higher than the resistance of conventional inrush limiting resistors. According to one embodiment, the total of the resistance values associated with resistors R2 and R3, according to one embodiment, is approximately in the range of 2 kilo ohms to 20 kilo ohms. In one example, R2 may be a 5 Kilo ohm resistor and R3 may be a 460 Ohm resistor providing a total resistance value of approximately 5.5 kilo ohms.

According to one embodiment, resistors R4 and R5 may be replaced with one to ten resistors. According to one embodiment, the resistors used to provide the functionality of R4 and R5 are very high impedance resistors, for example, in order to reduce power loss. According to one embodiment, the resistance value of R7 is approximately 10 kilo ohm. As depicted in FIG. 4, transistor Q1 is MOSFET and transistor Q2 is a bipolar transistor.

Optionally, the line voltage rectifier 230 could be implemented with a D1 bridge. In this case, according to one embodiment, the bridge's pin 1 could be the negative line 14, the bridge's pin 2 could be the reference line (−) 20, the bridge's pin 4 could be the positive line (+) 22. Conventionally, a D1 bridge's pin 2 is directly connected to GND2. However, according to one embodiment, the D1 bridge's pin 2 is instead directly connected to the reference line (−) 20.

According to one embodiment, the resistor network R2, R3 limits the current flowing into the bulk capacitor 140. According to one embodiment, the bulk capacitor 140 is charged slowly through the resistor network R2, R3 when the power switch Q1 is off and is charged more quickly through the power switch Q1 when the power switch Q1 is on. The bulk capacitor 140 is charged slowly when the power switch Q1 is off because the bulk capacitor 140 is charged with current that flows from the power grid through the resistor network R2, R3 before reaching the bulk capacitor 140. The bulk capacitor 140 is charged more quickly when the power switch Q1 is on because current from the power grid can reach the bulk capacitor 140 without going through the resistor network R2, R3.

According to one embodiment, the resistor network R2, R3 also provides a voltage to transistor Q2, which in turn actively turns the power switch Q1 off. The power switch Q1 turns on if the voltage network R4, R5, R7 provides sufficient voltage at the gate G of power switch Q1, according to one embodiment.

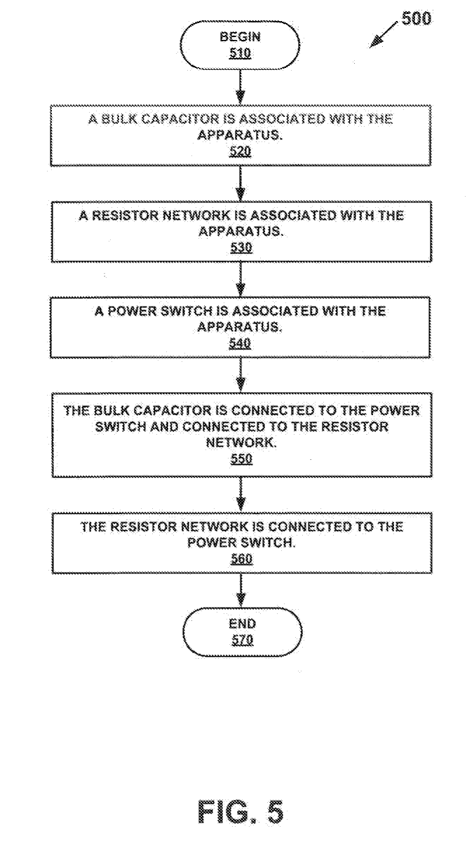

FIG. 5 depicts a flowchart of a method for manufacturing an apparatus 100, 200, 400 (FIGS. 1, 2, 4) that provides in rush, current tolerance for an electronic device, according to one embodiment. Although specific operations are disclosed in flowchart 500, such operations are exemplary. That is, embodiments of the present invention are well suited to performing various other operations or variations of the operations recited in flowchart 500. It is appreciated that the operations in flowchart 500 may be performed in an order different than presented, and that not all of the operations in flowchart 500 may be performed.

At operation 510, the method begins.

At operation 520, a bulk capacitor 140 is associated with the apparatus 100, 200.

At operation 530, a resistor network 150 is associated with the apparatus 100, 200.

At operation 540, a power switch 160 is associated with the apparatus 100, 200.

At operation 550, the bulk capacitor 140 is connected to the power switch 160 and is connected to the resistor network 150.

At operation 560, the resistor network 150 is connected to the power switch 160.

At operation 570, the method ends.

According to one embodiment, a voltage sense circuit 240 is associated with the apparatus 100, 200. The voltage sense circuit 240 can be connected to the power switch 160 and can be connected to the resistor network 150. According to one embodiment, a current sense switch is associated with the apparatus. The current sense circuit 250 can be connected to the resistor network 150 and connected to the power switch 160. A control circuit can be associated with the apparatus 100, 200. The control circuit can be connected to the voltage sense circuit 240, the power switch 160, and the current sense switch.

The state of the art has focused on designing, power supplies that can avoid high inrush currents while, at the same time charging bulk capacitors more and more quickly. Therefore, current efforts in the art teach away from various embodiments described herein that provide for charging a bulk capacitor 140 more slowly.

An apparatus 100, 200, 400 (FIG. 1, 2, or 4) provides increased power quality, reliability, energy efficiency and reduces costs. For emerging markets, power quality and reliability are more important, than energy efficiency. The energy efficiency provided by an apparatus 100, 200, 400 (FIG. 1, 2, or 4) is more important to developed countries, such as Europe and the United States (US). For example, conventional inrush limiting devices typically use NTC resistors that depend on temperature. The power loss produced by NTC resistor depends on the temperature of the device. The temperature of the device depends on ambient temperature but more upon the current conducted by the device. The higher the current the hotter the device and the lower the resistance and vice versa.

For example, assume, that a conventional power supply has a 4.7 ohm NTC resistor. When the conventional power supply is up and running, the inrush event has passed. Depending on the current drawn from the power grid, which is a function of the power drawn by the system the conventional power supply is feeding, the resistance of the 4.7 NTC ohm resistor, for example, may drop to 1 ohm at full load, which means that at that point, the conventional power supply is supplying 100 percent power to the system it feeds. In this example, the 4.7 ohm resistor's resistance would drop to 1 ohm of resistance. Assuming a current of 2 Amps conducted by the NTC, the result will be 4 Watts of power loss. In contrast, according to one embodiment, a semi conductor is used for the power switch 160 (FIGS. 1, 2, and 4) so that the power switch 160's resistance is independent of temperature. The resistance, according to one embodiment, of a power switch 160 may be, for example, 250 milliohms. Assuming a current of 2 Amps, the result will be 1 Watt of power loss. In this case, power switch 160, according to one embodiment, would result in 4 times less power loss than a conventional NTC resistor in a conventional power supply.

When a system that the power supply feeds is shut down or in sleep or stand by mode, current is still flowing through the power supply even though the power supply is not doing any work. Continuing the example, the resistance of the conventional power supply with the 4.7 NTC ohm resistor will rise to 4.7 ohms during sleep or stand by mode. At this point, there is less current but 4.7 times more resistance, which again results in power loss. Assuming a current of 0.1 Amps conducted by the NTC, the result will be 0.047 Watts of power loss. In contrast, once an in rush event is over, the power switch 160, provided according to various embodiments, will be the only component in the apparatus 100, 200, 400 (FIGS. 1, 2 and 4) conducting power, according to one embodiment. Since, according to one embodiment, the power switch 160 is not temperature dependent the resistance of power switch 160 will be approximately the same regardless of whether the system that the apparatus 100, 200, 400 feeds is running at full load, is in stand by or is in sleep mode, or has woken up from stand by or sleep mode. Assuming a current of 0.1 Amps, the result will be 0.0025 Watts of power loss for an apparatus 100, 200, 400, according to various embodiment.

Since, according to one embodiment, the apparatus 100, 200, 400 provides a reduction in power losses while providing inrush current tolerance, it is easier to comply with world wide energy efficiency requirements. Further since according to one embodiment, the same apparatus 100, 200, 400 can comply with world wide energy efficiency requirements the cost of manufacturing can be reduced. For example, instead of manufacturing different apparatuses for different countries the same apparatus 100, 200, 400 can be used in all electronic devices that are shipped to all of the countries of the world.

By reducing or possibly even eliminating the in rush current, there is less stress on components that are on the in rush current path. Since, according to one embodiment, there is less stress on the components, the components are less likely to break. For example, the cost of warranties can be reduced and the cost of replacing pails can also be reduced since the components are less likely to break.

Over dimensioned components associated with conventional apparatuses can be costly in terms of the materials used for building them, their complexity, and the cost for buying them. Costs can further be reduced because according to one embodiment, components along the inrush current path of an apparatus 100, 200, 400 are no longer over dimensioned in order to withstand in rush current.

Although various embodiments were described in the context of a power supply, various embodiments can be used for any type of in rush current tolerant topology. For example, various embodiments can be used for providing an adapter with an in rush current tolerant topology.

Various embodiments described herein can be used in combination with embodiments described in EPO application serial no. 07291045.8 titled “METHOD AND APPARATUS FOR A POWER CONVERSION DEVICE” by Wegener et al., attorney docket number HP200700363-1. For example, various embodiments described herein can provide a cost effective power switch that can be used in combination with various embodiments described in HP200700663-1.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations. However, any two or more embodiments, may be combined. Further, any embodiment may be used separately from any other embodiments. Phrases such as “an embodiment,” “one embodiment,” among, others, used herein, are not necessarily referring to the same embodiment. Features, structures, or characteristics of any embodiment may be combined in any suitable manner with one or more other features, structures, or characteristics.

1. An apparatus (100) for providing in rush current tolerance to an electronic device, the apparatus comprising:
means (150) for charging a bulk capacitor (140) slowly using a resistor network (150);
means for charging a bulk capacitor (140) more quickly; and
means (160) for alternating between the means (150) for charging the bulk capacitor (140) slowly and the means for charging the bulk capacitor (140) more quickly.

2. The apparatus (100) of claim 1, wherein the means (160) for alternating further comprises:
means for only charging through the means for charging slowly until a voltage across the means (150) for charging slowly is insufficient to keep the means (160) for alternating off.

3. The apparatus (100) of claim 1, wherein the means for alternating (160) further comprises:
means (240) for using the means (150) for charging slowly at some point in time after an instantaneous sinusoidal line voltage falls below a threshold; and,
means (250) for using the means for charging more quickly at some point in time after the instantaneous sinusoidal line voltage rises above the threshold.

4. The apparatus (100) of claim 1, wherein the means (160) for alternating further comprises:
means (250) for charging through the means for charging more quickly after the bulk capacitor (140) has been charged to a point that a voltage across the means (150) for charging slow has decreased to a point that a power switch (160) remains on.

5. An apparatus (100) for providing in rush current tolerance to an electronic device, the apparatus (100) comprising:
a bulk capacitor (140);
a resistor network (150) configured for charging the bulk capacitor (140) slowly by impeding current from the power grid to the bulk capacitor (140); and
a power switch (160) configured for causing the bulk capacitor (140) to be charged slowly using the resistor network (150) when the power switch (160) is off and for causing the bulk capacitor (140) to be charged more quickly without impeding current with the resistor network (150) when the power switch (160) is on.

6. The apparatus (100) of claim 5, wherein the bulk capacitor (140) is charged only through the resistor network (150) until a voltage across the resistor network (150) is insufficient to keep the power switch (160) off.

7. The apparatus (100) of claim 5, further comprising:
a voltage sense circuit (240) configured for turning the power switch (160) on at some point in time after an instantaneous sinusoidal line voltage exceeds a threshold.

8. The apparatus (100) of claim 5, wherein the resistor network (150) includes a plurality of resistors and the threshold is based on a total of resistance values for resistors associated with the resistor network (150) and wherein the total resistance is in the range of 2 kilo ohms to 20 kilo ohms.

9. The apparatus (100) of claim 5, further comprising:
a current sense switch (160) configured for actively turning the power switch (160) off at some point in time after the instantaneous sinusoidal line voltage falls below a threshold.

10. The apparatus (100) of claim 5, wherein the bulk capacitor (140) is charged more quickly without using the resistor network (150) after the bulk capacitor (140) has been charged sufficiently to cause a voltage across the resistor network (150) to decrease to a point that the power switch (160) remains on.

11. A method (500) of manufacturing an apparatus (100) that provides in rush current tolerance in an electronic device, the method (500) comprising:
associating (520) a bulk capacitor (140) with the apparatus (100);
associating (530) a resistor network 150 with the apparatus (100), wherein the resistor network (150) is configured for charging the bulk capacitor (140) slowly by impeding current to the bulk capacitor (140);
associating (540) a power switch (160) with the apparatus (100), wherein the power switch (160) is configured for causing the bulk capacitor (140) to be charged slowly using the resistor network (150) when the power switch (160) is off and for causing the bulk capacitor (140) to be charged more quickly without impeding current through the resistor network (150) when the power switch (160) is on; and
connecting (550) the bulk capacitor (140) to the power switch (160) and to the resistor network (150); and
connecting (560) the resistor network (150) to the power switch (160).

12. The method (500) of claim 11, further comprising:
associating a voltage sense circuit (240) the apparatus (100), wherein the voltage sense circuit (240) is configured for turning the power switch (160) on at some point in time after an instantaneous sinusoidal line voltage exceeds a threshold; and
connecting the voltage sense circuit (240) to the power switch (160) and the resistor network (150).

13. The method (500) of claim 11, wherein the resistor network (150) includes a plurality of resistors and the threshold is based on a total of resistance values for resistors associated with the resistor network (150).

14. The method (500) of claim 11, further comprising:
associating a current sense switch (160) with the apparatus (100), wherein the current sense switch 160 is configured for actively turning the power switch (160) off at some point in time after the instantaneous sinusoidal line voltage falls below a threshold; and
connecting the current sense circuit (250) to the resistor network (150) and the power switch 160.

15. The method (500) of claim 11 further comprising:
associating a control circuit with the apparatus (100), wherein the control circuit is configured for receiving instructions from a voltage sense circuit (240) and a current sense circuit (250), wherein the control circuit is configured for turning the power switch (160) on and off based on the received instructions; and
connecting the control circuit to the voltage sense circuit (240), the power switch (160), and the current sense circuit (250).
